(19) United States
(12) Patent Application Publication
(10) Pub. No.: US 2013/0202935 A1
(43) Pub. Date: Aug. 8, 2013

(54) BATTERY PACK

(71) Applicant: Samsung SDI Co., Ltd., Yongin-City (KR)

(72) Inventors: Ho-Ryong Hwang, Yongin-City (KR); Sang-Hoon Lee, Yongin-City (KR)

(73) Assignee: Samsung SDI Co., Ltd., Yongin-City (KR)

(21) Appl. No.: 13/754,122

(22) Filed: Jan. 30, 2013

(30) Foreign Application Priority Data
Feb. 3, 2012 (KR) 10-2012-0011170

(51) Int. Cl. H01M 2/10

(52) U.S. Cl. CPC H01M 2/1016
USPC 429/99

(57) ABSTRACT

A battery pack includes a battery holder, a plurality of battery cells, and a case. The battery holder has accommodating holes for respectively accommodating the plurality of battery cells on a first side and at least one concave groove formed by removing one portion of the battery holder on a lateral side. The battery holder further has a plurality of first coupling members formed on a second side. The case substantially covers the battery holder having the plurality of battery cells accommodated therein. A first portion of the case has at least one coupling rib coupled to the concave groove. A second portion of the case has at least one second coupling member coupled to the first coupling member.

### CROSS-REFERENCE TO RELATED APPLICATIONS

This application claims priority to and the benefit of Korean Patent Application No. 10-2012-0011170, filed on Feb. 3, 2012, in the Korean Intellectual Property Office, the entire content of which is incorporated herein by reference.

### BACKGROUND

1. Field

Embodiments of the present disclosure relate to a battery pack, and more particularly, to a battery pack capable of stably accommodating battery cells in the inside of a case.

2. Description of the Related Art

Among battery cells, secondary batteries are rechargeable batteries, and have recently been widely used as energy sources of smart phones, notebook computers, electric-powered tools and electric vehicles.

Meanwhile, the structure of a secondary battery may be easily modified, depending on the kind of device using the secondary battery as an energy source. For example, when the secondary battery is used as an energy source of a device requiring a high-power source used in an electric bicycle or vehicle, a battery pack may be configured by connecting a plurality of secondary batteries.

Generally, the battery pack may include a plurality of secondary batteries, a battery holder for accommodating the plurality of secondary batteries, and a case for covering the battery holder so as to protect the battery holder. In the battery pack, the battery holder may be fixed to the inside of the case. However, in this case, the number of manufacturing processes and components of the battery pack is added, and therefore, the manufacturing cost of the battery pack may be increased.

### SUMMARY

Embodiments provide a battery pack capable of stably accommodating battery cells such as secondary batteries in the inside of a case.

According to an aspect of the present disclosure, a battery pack includes a battery holder, a plurality of battery cells, and a case.

The battery holder has accommodating holes for respectively accommodating the plurality of battery cells and at least one concave groove formed by removing one portion of the battery holder.

The case covers the battery holder having the plurality of battery cells accommodated therein, and has at least one coupling rib coupled to the concave groove.

The plurality of battery cells may be secondary batteries.

In certain embodiments of the battery pack according to the present disclosure, a separate component such as a screw or adhesive is not used and, instead, it is possible to prevent a battery holder from being moved in the inside of a case using the structure of the case and the battery holder. Thus, although an external impact is applied to the battery pack, the battery holder having battery cells accommodated therein can be stably accommodated in the case.

In an embodiment, a battery pack is provided. The battery pack comprises a battery holder and a battery case. The battery holder comprises a front side of the battery holder that receives a plurality of battery cells and a plurality of lateral sides including at least one lateral side having a plurality of grooves formed inward of the surface of the at least one lateral side. The battery case comprises a first case that covers a first portion of the battery holder. The first case includes a plurality of ribs that mechanically engage the plurality of grooves and attach the first case to the first portion of the battery holder. The battery case further comprises a second case that covers a second portion of the battery holder. The second case is mechanically attached to the second portion of the battery holder.

At least a portion of the plurality of grooves may be formed as generally V-shaped notches each having upper and lower surfaces. At least a portion of the plurality of ribs may be mounted on a lower surface of the V-shaped notches.

The plurality of grooves and the plurality of ribs may be formed adjacent to a selected lateral side of the battery pack.

The battery pack further comprises a top side having a plurality of first coupling members extend outward from the top tide.

The second case may further comprise a plurality of second coupling members. The second case may be mechanically attached to the second portion of the battery holder by frictional engagement of the first and second coupling members.

At least a portion of the second coupling members may be received within the first coupling members.

The first and second coupling members may each have a plurality of sidewalls forming a closed sided structure and having an open top.

The battery holder may be substantially enclosed by the first and second cases.

The first and second cases may be mechanically attached to each other.

### BRIEF DESCRIPTION OF THE DRAWINGS

The accompanying drawings, together with the specification, illustrate exemplary embodiments of the present disclosure, and, together with the description, serve to explain the principles of the present disclosure.

FIG. 1 is an exploded perspective view of a battery pack according to an embodiment of the present disclosure.

FIG. 2 is a partial perspective view of a battery holder shown in FIG. 1.

FIG. 3 is a perspective view of a second case shown in FIG. 1.

FIG. 4 is a sectional view showing a state in which the second case and battery holder shown in FIG. 1 are coupled to each other.

FIG. 5 is a sectional view taken along line I-I′ of FIG. 1.

FIG. 6 is a sectional view showing a state in which an external impact is applied to the battery pack shown in FIG. 5.

### DETAILED DESCRIPTION

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

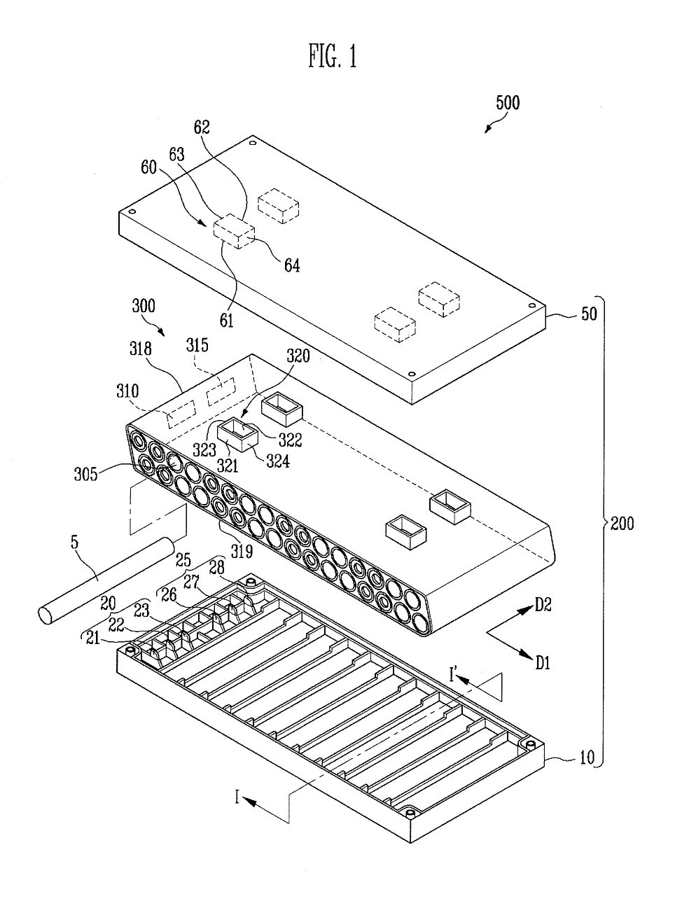

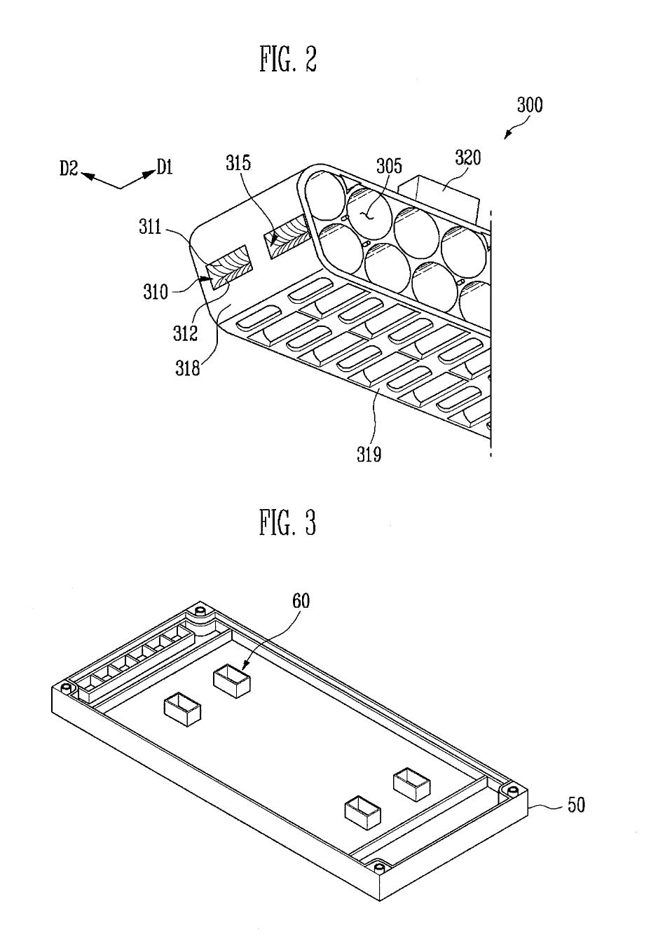

FIG. 1 is an exploded perspective view of a battery pack according to an embodiment of the present disclosure. FIG. 2 is a partial perspective view of a battery holder shown in FIG. 1. FIG. 3 is a perspective view of a second case shown in FIG. 1.

Referring to FIGS. 1, 2, and 3, the battery pack 500 according to this embodiment includes a plurality of battery cells 5, a battery holder 300, and a case 200.

In this embodiment, each of the plurality of battery cells 5 may be a rechargeable secondary battery, and the plurality of battery cells 5 are accommodated one by one in a plurality of accommodating holes 305 formed in the battery holder 300. In this embodiment, the plurality of battery cells 5 may be arranged into a two-layered structure of upper or lower layers in the battery holder 300. A battery cell in the lower layer is disposed at a corresponding position between two adjacent battery cells in the upper layer. That is, the plurality of battery cells 5 in the upper and lower layers of the battery holder 300 are arranged in a zigzag form.

The battery holder 300 has the plurality of accommodating holes 305 spaced apart from one another in the inside thereof. Each of the plurality of accommodating holes or cavities 305 may be formed by removing a portion of the battery holder 300 in a first direction D1 corresponding to the length direction of the battery cell. The plurality of battery cells 5 extended in the first direction D1 are accommodated one by one in the plurality of accommodating holes 305.

Meanwhile, if the side or lateral surface of the battery holder 300, neighboring to the surface on which the plurality of accommodating holes 305 are formed (e.g., a front surface), at least one of the side surfaces is a coupling surface 318. For example, as illustrated in FIG. 1, the plurality of battery cells 5 are arranged in the zigzag form in the upper and lower layers of the battery holder 300, and therefore, the coupling surface 318 is inclined with respect to a bottom surface 319 of the battery holder 300.

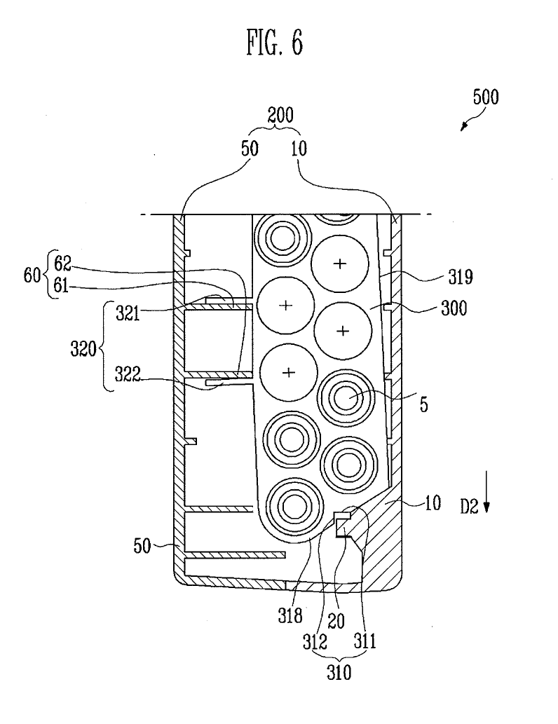

One or more grooves may be formed on the coupling surface 318 for coupling the battery holder 300 to the case 200. In certain embodiments, the grooves may be concave in shape. For example, as illustrated in FIG. 2, a first concave groove 310 and a second concave groove 315 are formed on and inward of the coupling surface 318. The first and second concave groove 310 and 315 are components for coupling the battery holder 300 to the case 200. More specifically, as discussed in greater detail below with respect to FIG. 5, the first concave groove 310 is coupled to a plurality of first coupling ribs 20 of a first case 10 of the case 200, and the second concave groove 315 is coupled to a plurality of second coupling ribs 25 of the first case 10 of the case 200.

In certain embodiments, when two or more grooves are formed on the coupling surface 318, the grooves may have the same structure or may have different structures. For example, as illustrated in FIG. 2, the first and second concave grooves 310 and 315 have the same structure. Therefore, the structure of the first concave groove 310 will be described as an example, and the description of the structure of the second concave groove 315 will be omitted.

The first concave groove 310 is formed on the coupling surface 318 by removing a portion of the battery holder 300, and has a first surface 311 and a second surface 312. The first and second surfaces 311 and 312 are inclined in different directions with respect to the coupling surface 318. For example, the first surface 311 may be inclined in a direction towards from the bottom surface 319 of the battery holder 300 and the second surface 312 may be positioned above the first surface 311 and inclined in a direction away from the bottom surface 319.

Accordingly, the first concave groove 310 is formed as a notch (e.g., a generally V-shaped notch) of which the inside is inclined by the first and second surfaces 311 and 312 so that the first coupling ribs 20 are latched to the first concave groove 310. Thus, the battery holder 300 is accommodated in the inside of the first case 10, so that it is possible to minimize the movement of the battery holder 300 in the inside of the first case 10. This will be described in detail with reference to FIGS. 5 and 6.

Meanwhile, a plurality of first coupling members 320 are provided on the battery holder 300. For example, the plurality of first coupling members 320 may be formed on a top surface of the battery holder 300 that is positioned on a surface across from the bottom surface 319. The first coupling member 320 is a component for coupling the battery holder 300 to a second case 50 of the case 200. Each of the first coupling members 320 is coupled to a corresponding second coupling member 60 of the second case 50 that is dimensioned to receive its corresponding first coupling member 320 (e.g., frictionally coupled).

With the first and second cases 10 and 50 secured to the battery holder 300 in this manner, the battery holder 300 may be substantially enclosed by the case 200. That is to say, in certain embodiments, the battery holder 300 may not be exposed outside of the case, as illustrated in greater detail in FIGS. 5 and 6.

In this embodiment, the number of each of the first and second coupling members 320 and 60 may be four, and the four first coupling members 320 may be coupled one by one to the four second coupling members 60. Alternatively, the number of each of the first and second coupling members 320 and 60 may be less than or more than four.

In this embodiment, the first coupling member 320 may have a box shape (e.g., a rectangular shape) having an opened top and an empty inside. More specifically, the first coupling member 320 includes a first partition wall 321, a second partition wall 322, a third partition wall 323 and a fourth partition wall 324. The first and second partition walls 321 and 322 are approximately parallel with a second direction D2 and approximately perpendicular to the first direction D1. The third and fourth partition walls 323 and 324 are approximately parallel with the first direction D1 and approximately perpendicular to the second direction D2. The first and second partition walls 321 and 322 are opposite to each other while being spaced apart from each other, and the third partition wall 323 connects one ends of the first and second partition walls 321 and 322. The fourth partition wall 324 connects the other ends of the first and second partition walls 321 and 322. Thus, the first coupling members may be formed as a closed sided structure having an open top.

The case 200 includes the first case 10 covering one side of the battery holder 300 and a second case 50 covering the other side of the battery holder 300. As shown in FIGS. 1 and 5, the first case 10 covers a lower portion of the battery holder 300 (e.g., adjacent to the bottom surface 19) and the second case 50 covers an upper portion of the battery holder 300 (e.g., adjacent to the top surface) The second case 50 is coupled to the first case 10, so that both the first and second cases 10 and 50 cover the battery holder 300.

The first case 10 includes a plurality of coupling ribs protruded from an inner surface thereof.

In this embodiment, the plurality of coupling ribs includes the first coupling ribs 20 and the second coupling ribs 25. The first and second coupling ribs 20 and 25 may possess a generally elongate configuration, extending in the second direction D2. The first and second coupling ribs 20 and 25 may be further arranged in the first direction D1 (e.g., side-by-side) adjacent to one side of the first case 10.

In this embodiment, the first coupling ribs 20 include a first rib 21, a second rib 22, and a third rib 23, and are coupled to the first concave groove 310. The second coupling ribs 20 include a fourth rib 26, a fifth rib 27, and a sixth rib 28, and are coupled to the second concave groove 315. The coupling structure of the plurality of coupling ribs to the first and second concave grooves 310 and 315 will be described in detail with reference to FIG. 5.

The second case 50 is coupled to the first case 10 so as to cover the upper portion of the battery holder 300, and the second coupling members 60 are provided on a surface of the second case 50 (e.g., the bottom surface 319), adjacent to the battery holder 300.

In this embodiment, the second coupling members 60 have a box shape (e.g., a rectangular shape) having an opened top and an empty inside, corresponding to the shape of the first coupling member 320. The second coupling members 60 are further formed on a surface of the second case 50 facing the battery holder 300. The size of the second coupling members 60 is smaller than that of the first coupling members 320 so that the second coupling members 60 can be inserted into the inside of the first coupling members 320. More specifically, the second coupling member 60 includes a fifth partition wall 61, a sixth partition wall 62, a seventh partition wall 63, and an eighth partition wall 64, respectively corresponding to the first to fourth partition walls 321, 322, 323, and 324. Thus, the second coupling members may be formed as a closed sided structure having an open top. The coupling structure of the first and second coupling members 320 and 60 will be described as follows.

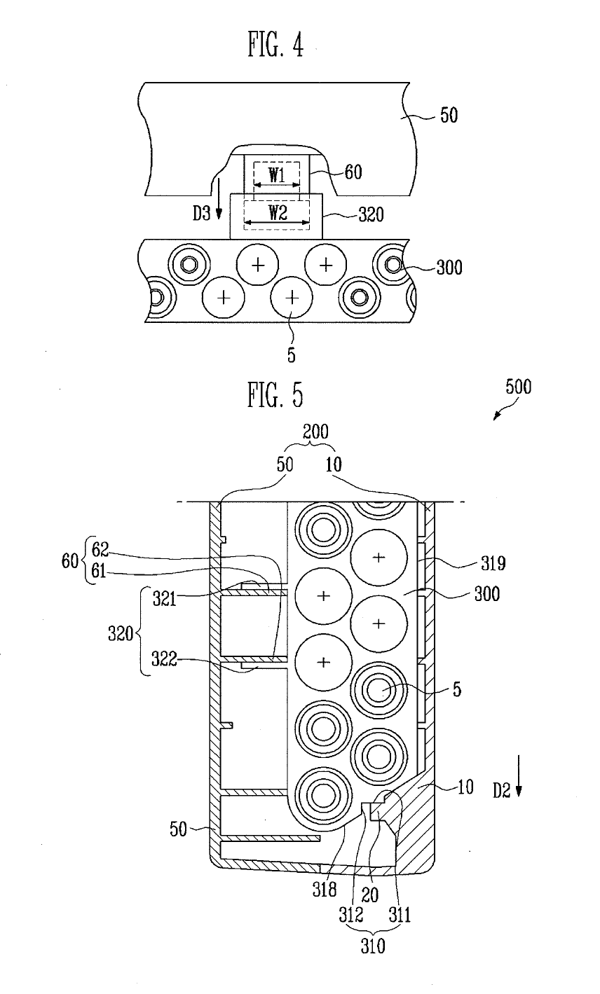

FIG. 4 is a sectional view showing a state in which the second case and battery holder shown in FIG. 1 are coupled to each other.

Referring to FIGS. 3 and 4, each of the first and second coupling members 320 and 60 includes four sidewalls and has a box shape having an opened top and an empty inside, as described with reference to FIGS. 1 to 3. The inner space of the first coupling member 320 has a second width W2, and the inner space of the second coupling member 60 has a first width W1 smaller than the second width W2.

Thus, the second coupling member 60 is provided in a third direction D3 to the first coupling member 320 so as to be inserted into the inner space of the first coupling member 320. Accordingly, the battery holder 300 can be stably accommodated in the second case 50 by the coupling between the first and second coupling members 320 and 60. For example, in one embodiment, first and second coupling members 320 and 60 may be dimensioned such that they frictionally engage one another and mechanically secure the second case 50 to the battery holder 300. It may be understood, however, that other mechanical engagement mechanisms may be employed to couple the first and second coupling members 320 and 60 without departing from the spirit of the disclosed embodiments.

Meanwhile, in this embodiment, each of the first and second coupling members 320 and 60 has the box shape having the opened top and the empty inside as described above. Alternatively, each of the first and second coupling members 320 and 60 may have another shape, e.g., a circular or polygonal column shape having an opened top and an empty inside so that one of the coupling members is accommodated in the other of the coupling members and thus the coupling members are coupled to each other.

FIG. 5 is a sectional view taken along line I-I′ of FIG. 1. FIG. 6 is a sectional view showing a state in which an external impact is applied to the battery pack shown in FIG. 5.

Referring to FIG. 5, the first coupling member 320 is coupled to the second coupling member 60, and the first coupling ribs 20 is mounted on the second surface 312 of the first concave groove 310 so as to be coupled to the first concave groove 310, as described with reference to FIGS. 1 to 4. The first partition wall 321 comes in contact with the fifth partition wall 61, and the second partition wall 322 comes in contact with the sixth partition wall 62, so that the movement of the battery holder 300 in the case 200 is almost prevented.

Referring to FIG. 6, a fine interval between the second partition wall 322 and the sixth partition wall 62 is generated by forming an assembly tolerance between the first and second coupling members 320 and 60 so as to facilitate assembling between the first and second coupling members 320 and 60. Thus, the impact occurring as the battery pack 500 drops in the second direction D2 may cause the movement of the battery holder 300 in the case 200. In a case in which the first concave groove 310 is not formed on the coupling surface 318, the coupling surface 318 of the battery holder 300 is slid on the first coupling ribs 20, and therefore, the battery holder 300 may be moved in the case 200. However, in this embodiment, the first concave groove 310 is formed on the coupling surface 318, so that although an external impact is applied to the battery pack 500, the first coupling ribs 20 are latched to the first concave groove 310. Accordingly, it is possible to minimize the movement of the battery holder 300 in the case 200.

While the present disclosure has been described in connection with certain exemplary embodiments, it is to be understood that the disclosure is not limited to the disclosed embodiments, but, on the contrary, is intended to cover various modifications and equivalent arrangements included within the spirit and scope of the appended claims, and equivalents thereof.

What is claimed is:

1. A battery pack comprising:
a plurality of battery cells;
a battery holder having accommodating holes for respectively accommodating the plurality of battery cells and at least one concave groove formed by removing one portion of the battery holder; and
a case covering the battery holder having the plurality of battery cells accommodated therein, and having at least one coupling rib coupled to the concave groove.

2. The battery pack according to claim 1, wherein the battery holder further comprises a first coupling member provided on a surface thereof which faces the case, and the case further comprises a second coupling member coupled to the first coupling member.

3. The battery pack according to claim 2, wherein any one of the first and second coupling members is accommodated in the other of the first and second coupling members so that the first and second coupling members are coupled to each other.

4. The battery pack according to claim 3, wherein each of the first and second coupling members comprises a plurality of partition walls, and at least one of the first and second coupling members has a shape having an opened top.

5. The battery pack according to claim 4, wherein the first coupling member comprises:
a first partition wall;
a second partition wall spaced apart from the first partition wall so as to be opposite to the first partition wall;
a third partition wall connecting one ends of the first and second partition walls; and
a fourth partition wall opposite to the third partition wall, the fourth partition wall connecting the other ends of the first and second partition walls,
wherein the second coupling member is opposite to the first coupling member, and comprises four partition walls respectively corresponding to the first, second, third and fourth partition walls.

6. The battery pack according to claim 2, wherein the case comprises:
a first case covering one side of the battery holder; and
a second case covering the other side of the battery holder.

7. The battery pack according to claim 6, wherein the coupling rib is provided to the first case, and the second coupling member is provided to the second case.

8. The battery pack according to claim 1, wherein the concave groove is formed as a notch of which the inside is inclined.

9. The battery pack according to claim 8, wherein the concave groove is defined by a first surface and a second surface connected to the first surface so as to be formed on a coupling surface of the battery holder, and the first and second surfaces are inclined in different directions with respect to the coupling surface.

10. The battery pack according to claim 9, wherein the length direction of the accommodating holes is approximately parallel with the coupling surface, and the length direction of the accommodating holes is approximately vertical to the direction in which the coupling rib is extended.

11. The battery pack according to claim 9, wherein the plurality of battery cells are accommodated in the battery holder divided into an upper layer and a lower layer, and the plurality of battery cells are arranged in a zigzag form in the upper and lower layers.

12. A battery pack, comprising:
a battery holder comprising:
a front side of the battery holder that receives a plurality of battery cells; and
a plurality of lateral sides including at least one lateral side having a plurality of grooves formed inward of the surface of the at least one lateral side; and
a battery case, comprising:
a first case that covers a first portion of the battery holder, wherein the first case includes a plurality of ribs that mechanically engage the plurality of grooves and attach the first case to the first portion of the battery holder; and
a second case that covers a second portion of the battery holder, wherein the second case is mechanically attached to the second portion of the battery holder.

13. The battery pack of claim 12, wherein at least a portion of the plurality of grooves are formed as generally V-shaped notches each having upper and lower surfaces and wherein at least a portion of the plurality of ribs are mounted on a lower surface of the V-shaped notches.

14. The battery pack of claim 12, wherein the plurality of grooves and the plurality of ribs are formed adjacent to a selected lateral side of the battery pack.

15. The battery pack of claim 12, further comprising a top side having a plurality of first coupling members extend outward from the top tide.

16. The battery pack of claim 15, the second case further comprising a plurality of second coupling members, wherein second case is mechanically attached to the second portion of the battery holder by frictional engagement of the first and second coupling members.

17. The battery pack of claim 16, wherein the at least a portion of the second coupling members are received within the first coupling members.

18. The battery pack of claim 16, wherein the first and second coupling members each have a plurality of sidewalls forming a closed sided structure and having an open top.

19. The battery pack of claim 12, wherein the battery holder is substantially enclosed by the first and second cases.

20. The battery pack of claim 12, wherein the first and second cases are mechanically attached to each other.
